(19) United States
(12) Patent Application Publication
(10) Pub. No.: US 2012/0158768 A1
(43) Pub. Date: Jun. 21, 2012

(54) DECOMPOSING AND MERGING REGULAR EXPRESSIONS

(75) Inventors: Charles William Lamanna, Bellevue, WA (US); Mauktik H. Gandhi, Redmond, WA (US); Jason Eric Brewer, Kirkland, WA (US)

(73) Assignee: Microsoft Corporation, Redmond, WA (US)

(21) Appl. No.: 12/968,618

(22) Filed: Dec. 15, 2010

(51) Int. Cl. G06F 17/30

(52) U.S. Cl. 707/769; 707/E17.039

(57) ABSTRACT

The present invention extends to methods, systems, and computer program products for decomposing and merging regular expressions. Embodiments of the invention decompose a regular expression into multiple simple keyword graphs, merge those keyword graphs in a compact and efficient manner, and produce a directed acyclic graph (DAG) that can execute a simplified regular expression alphabet. Several of these regular expression DAG's can then be merged together to produce a single DAG that represents an entire collection of regular expressions. DAGs along with other text processing algorithms and a heap collection can be combined in a multi-pass approach to expand the regular expression alphabet.

### CROSS-REFERENCE TO RELATED APPLICATIONS

Not Applicable.

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

In some computing environments, regular expressions are used to match strings of text, such as, for example, particular characters, words, or patterns of characters. Regular expressions can be written in a formal language that can be interpreted by a regular expression processor. The regular expression processor is a program that serves as a parser generator or examines text and identifies parts that match a provided specification.

Regular expressions are used by many text editors, utilities, and programming languages to search and manipulate text based on patterns. For example, anti-spam services can utilize regular expressions to determine if strings of text known to be indicative of SPAM are contained in an electronic message. Similarly, data leakage protection services can utilize regular expressions to detect and prevent the unauthorized use and transmission of confidential information.

In environments that utilize regular expressions, it is not uncommon for large collections of regular expressions to be executed sequentially. For example, an anti-spam service can use tens of thousands of regular expressions when determining if an electronic message contains SPAM. Regular expressions within a set of regular expressions can be run sequentially against each received electronic message. Sequential execution of regular expressions limits scalability and can consume significant resources as the number of regular expressions and/or portions of text being checked for matches increases.

### BRIEF SUMMARY

The present invention extends to methods, systems, and computer program products for decomposing and merging regular expressions. One or more keyword graphs are accessed. The one or more keyword graphs were decomposed from a first regular expression. Each of the one or more keyword graphs has a root node, one or more intermediate nodes, and a leaf node. Each of the one or more intermediate nodes and the leaf node indentify a character pattern that partially matches the first regular expression. The root node and each of the one or more intermediate nodes have a single child node. One of the intermediate nodes has the leaf node as a child node. Each leaf node is labeled as a matching state for the first regular expression.

A second graph is accessed. The second graph represents a second regular expression. The second graph has a root node, one or more intermediate nodes, and one or more leaf nodes. Each of the one or more intermediate nodes and the one or more leaf nodes indentify a character pattern that partially matches the second regular expression. The second graph has one or more terminal nodes labeled as a matching state for the second regular expression.

The one or more keyword graphs and the second graph are merged into a directed acyclic graph that collectively represents both the first regular expression and the second regular expression. Merging includes identifying any similarly positioned intermediate nodes within the one or more keyword graphs and the second graph that have at least partially overlapping character patterns. For any identified intermediate nodes that have partially overlapping character patterns, the character pattern of at least one of the indentified intermediate nodes is altered to eliminate the partially overlapping character pattern. An edge is added between the keyword graph and the second graph to compensate for altering the character pattern of the at least one of the identified intermediate nodes. For any identified intermediate nodes that have fully overlapping character patterns, the intermediate node in the keyword graph and the intermediate node in the second graph are combined into a single node representing the fully overlapping character pattern.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates decomposing and merging regular expressions.

FIG. 2 illustrates an example of decomposing a graph that represents a regular expression.

FIG. 3 illustrate an example of merging graphs that represent different regular expressions.

FIG. 4 illustrates another example of decomposing a graph that represents a regular expression.

FIG. 5 illustrates another example of merging graphs that represent different regular expressions.

FIG. 6 illustrates a flow chart of an example method for decomposing and merging regular expressions.

### DETAILED DESCRIPTION

The present invention extends to methods, systems, and computer program products for decomposing and merging regular expressions. One or more keyword graphs are accessed. The one or more keyword graphs were decomposed from a first regular expression. Each of the one or more keyword graphs has a root node, one or more intermediate nodes, and a leaf node. Each of the one or more intermediate nodes and the leaf node indentify a character pattern that partially matches the first regular expression. The root node and each of the one or more intermediate nodes have a single child node. One of the intermediate nodes has the leaf node as a child node. Each leaf node is labeled as a matching state for the first regular expression.

A second graph is accessed. The second graph represents a second regular expression. The second graph has a root node, one or more intermediate nodes, and one or more leaf nodes. Each of the one or more intermediate nodes and the one or more leaf nodes indentify a character pattern that partially matches the second regular expression. The second graph has one or more terminal nodes labeled as a matching state for the second regular expression.

The one or more keyword graphs and the second graph are merged into a directed acyclic graph that collectively represents both the first regular expression and the second regular expression. Merging includes identifying any similarly positioned intermediate nodes within the one or more keyword graphs and the second graph that have at least partially overlapping character patterns. For any identified intermediate nodes that have partially overlapping character patterns, the character pattern of at least one of the indentified intermediate nodes is altered to eliminate the partially overlapping character pattern. An edge is added between the keyword graph and the second graph to compensate for altering the character pattern of the at least one of the identified intermediate nodes. For any identified intermediate nodes that have fully overlapping character patterns, the intermediate node in the keyword graph and the intermediate node in the second graph are combined into a single node representing the fully overlapping character pattern.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Within this description and the following claims a “regular expression”, is a construct used to match strings of text, such as, for example, particular characters, words, or patterns of characters. In some embodiments, a regular expression has a limited alphabet. A regular expression can be written in a formal language that can be interpreted by a regular expression processor. The regular expression processor serves as a parser generator or examines text and identifies parts of the text that match a provided regular expression.

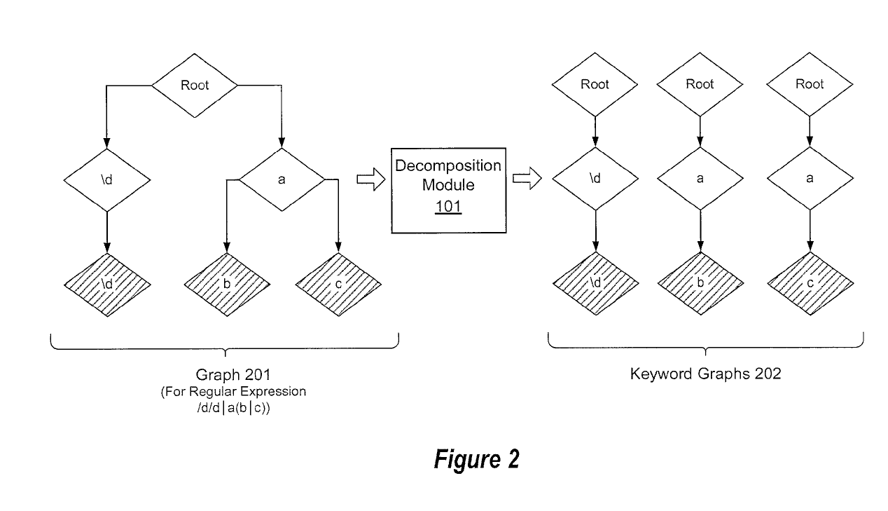

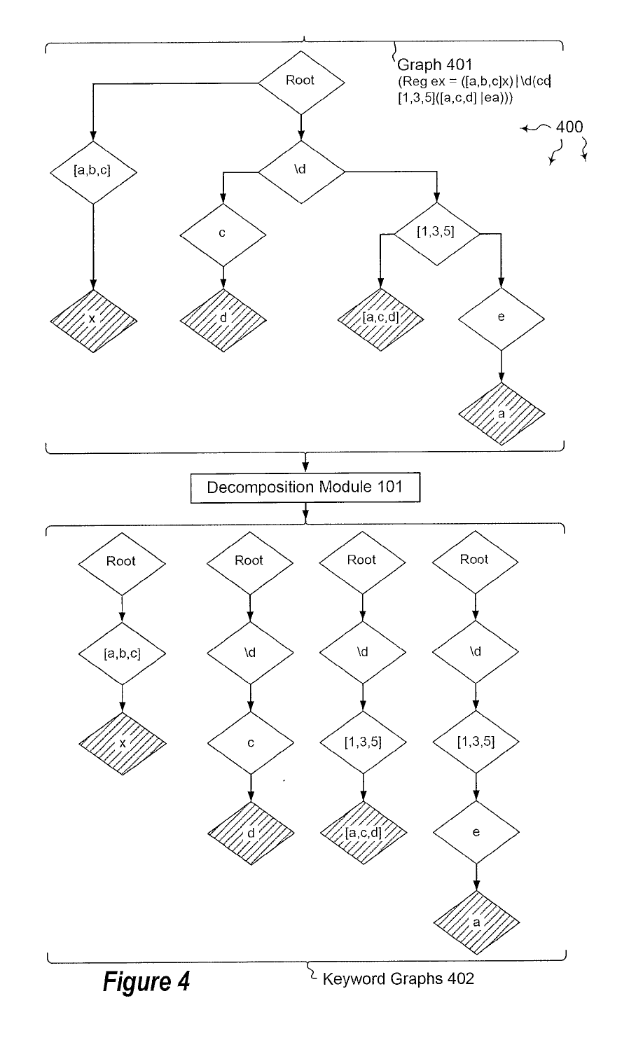

In generally, graphs can be used to represent regular expressions and their matching states. For example, turning briefly to FIG. 2, graph 201 represents the regular expression “(/d/d)|(a(b|c))”. Similarly, turning briefly to FIG. 4, graph 401 represents the regular expression “([a,b,c]x)|(\d(cd|[1,3,5]([a,c,d]|ea)))”. A graph can “run” by executing a state machine with input text, which allows parallelization of graphs.

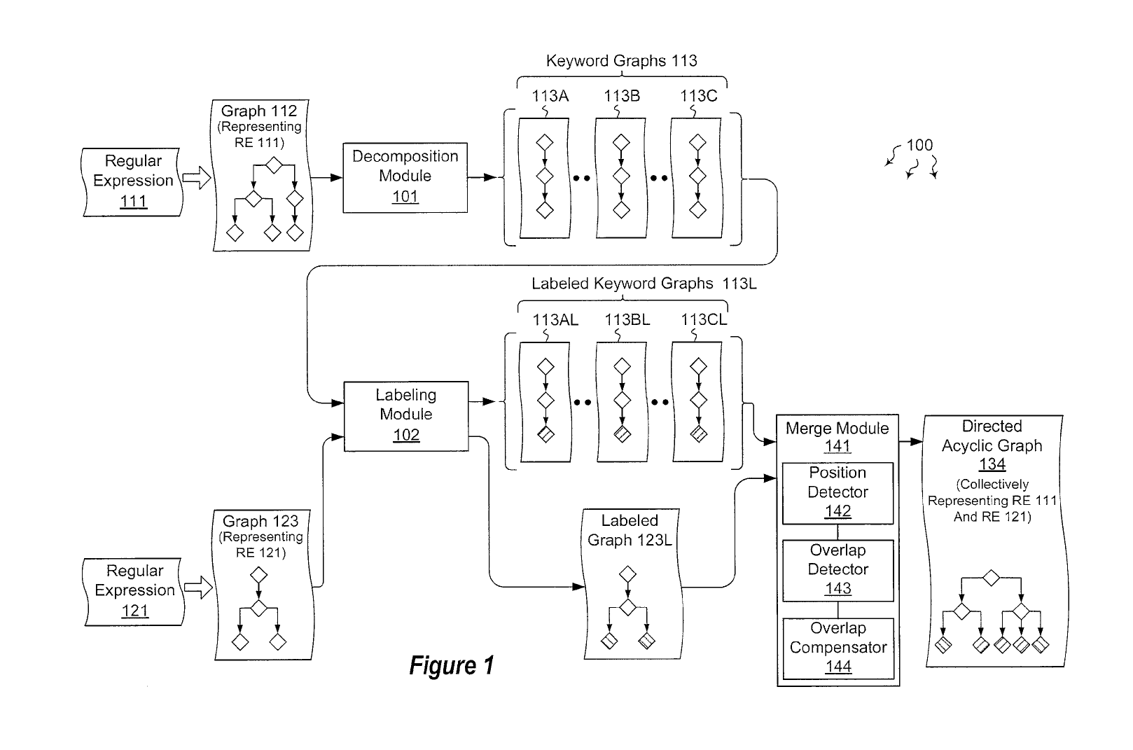

FIG. 1 illustrates an example computer architecture 100 that facilitates decomposing and merging regular expressions. Referring to FIG. 1, computer architecture 100 includes decomposition module 101, labeling module 102, and merge module 141. Each of the depicted components can be connected to one another over (or is part of) a network, such as, for example, a Local Area Network (“LAN”), a Wide Area Network (“WAN”), and even the Internet. Accordingly, each of the depicted comments as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

In general, decomposition can be used to produce a set of simple graphs that represent a regular expression from a more complex graph that represents the regular expression. Accordingly, decomposition module 101 is configured to decompose a graph, such as, for example, a graph representing a regular expression, into a corresponding plurality of keyword graphs. Decomposition module 101 can essentially remove disjunctive portions of a more complex regular expression to break the more complex regular expression into a plurality of simpler regular expressions. A leaf node of each keyword graph represents a terminal condition from the more complex graph (which may be at an intermediate node or leaf node in the more complex graph). Decomposition module 101 can decompose labeled or unlabeled graphs.

Labeling module 102 is configured to label nodes of a graph or keyword graph to indicate matching states for a represented regular expression. Labeling module 102 can label nodes before or after decomposition.

Turning again to FIG. 2, FIG. 2 illustrates an example of decomposing a graph that represents a regular expression. As depicted, decomposition module 101 receives graph 201 as input. Graph 201 was previously labeled (represented by the diagonal hatching) to indicate matching states for the regular expression “(/d/d)|(a(b|c))”. Decomposition module 101 decomposes graph 201 and outputs keyword graphs 202. The labels in graph 201 are carried over to keyword graphs 202. Thus, when text is compared to (run against) graph 201 or any of keyword graphs 202 any match is indicated as a match to “(/d/d)|(a(b|c))”.

Turning again to FIG. 4, FIG. 4 illustrates another example of decomposing a graph that represents a regular expression. As depicted, decomposition module 101 receives graph 401 as input. Graph 401 was previously labeled (represented by the diagonal hatching) to indicate matching states for the regular expression “([a,b,c]x)|(\d(cd|[1,3,5]([a,c,d]|ea)))”. Decomposition module 101 decomposes graph 401 and outputs keyword graphs 402. The labels in graph 401 are carried over to keyword graphs 402. Thus, when text is compared to (run against) graph 401 or any of keyword graphs 402 any match is indicated as a match to “([a,b,c]x)|(\d(cd\[1,3,5]([a,c,d]|ea)))”.

In some embodiments, a graph is decomposed into keyword graphs in accordance with the following algorithm:
Start at the root node.
Identify all the children nodes of the root node.
For each of these nodes:
   a. Copy the parent nodes above the node (call this “prefix.i”).
   b. Add this node and its subtree as a child to “prefix.i”.
   c. Start again from (2) except use the current node as the root node.

The algorithm can produce a collection of keyword graphs (e.g., DAGs) representing the graph. Each keyword graph has a single terminal node that is a leaf node. Within each graph, each node has a single child node.

In general, merging can be used to produce a single Directed Acyclic Graph (“DAG”) representing a collection of regular expressions. Accordingly, merge module 101 is configured to receive two graphs as input and merge the two graphs into a single DAG that collectively represents matching states for the two input graphs. To eliminate processing redundancies, merge module 101 can combine overlapping character patterns at similarly positioned nodes in the two input graphs into a single node in the single DAG. When character patterns partially overlap, merge module 101 can alter the character pattern at a node in one input graph. Merge module 101 can then compensate by adding an additional edge between the node and a corresponding node in the other input graph. Adding an additional edge facilitates equivalence in matching states between the two input graphs and the single DAG.

In some embodiments, merge module 141 merges two keyword graphs into a single DAG. In other embodiments, merge module 141 merges a keyword graph and another graph into a single DAG. The functionality of merge module 141 can be reused as needed to merge larger sets of graphs together.

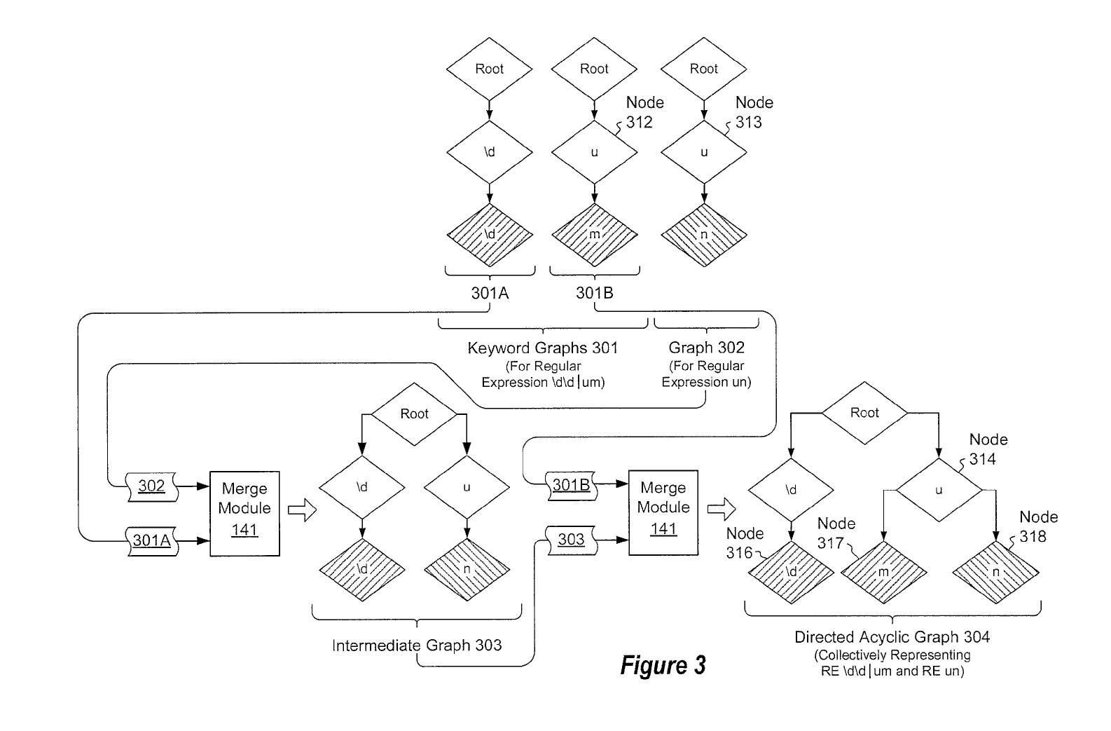

Turning to FIG. 3, merge module 141 merges keyword graphs 301 (e.g., previously decomposed from another graph) and graph 302 into directed acyclic graph 304. Merge module 141 utilizes graph 302 and keyword graph 301A as input. Merge module 141 merges graph 302 and keyword graph 301A into intermediate graph 303. Subsequently, merge module 141 utilizes intermediate graph 330 and keyword graph 301B. Merge module 141 merges intermediate graph 303 and keyword graph 301B into directed acyclic graph 304. Since the character patterns nodes 312 and 313 overlap, nodes 312 and 313 are merged into a single node 314 in directed acyclic graph 304.

Labels (as indicated by different diagonal hatching) are maintained throughout the merge process. Thus, terminal nodes indicate a regular expression that is matched. Nodes 316 and 317 indicate a match to the regular expression “\d\dlum” (the regular expression they were decomposed from) and node 318 indicates a match to the regular expression “un”.

As depicted in FIG. 3, inputs to merge module 141 are external. In other embodiments, merge module 141 receives a set of graphs as input and outputs a DAG. During processing, intermediate graphs are maintained and processed internally within merge module 141.

As depicted, merge module 141 includes position detector 142, overlap detector 143, and overlap compensator 144. During merging position, position detector 142 is configured to identify similarly positioned nodes within different graphs. Similarly positioned nodes can be identified based on a distance from the root node. For example, in FIG. 3, nodes 312 and 313 are similarly positioned. During merging, overlap detector 143 is configured to detect if character patterns of different nodes at least partially overlap. For example, the character pattern [1, 3, 5] partially matches the character pattern /d. On the other hand, the character pattern [a, b, c] and the character pattern [a, b, c] fully overlap. During merging, overlap compensator 144 is configured to compensate when nodes with partially overlapping character patterns are merged into a single node. Compensation can include adding edges between input graphs that are being merged. The additional edges facilitate equivalence between matching states of the input graphs and matching states of resulting DAG.

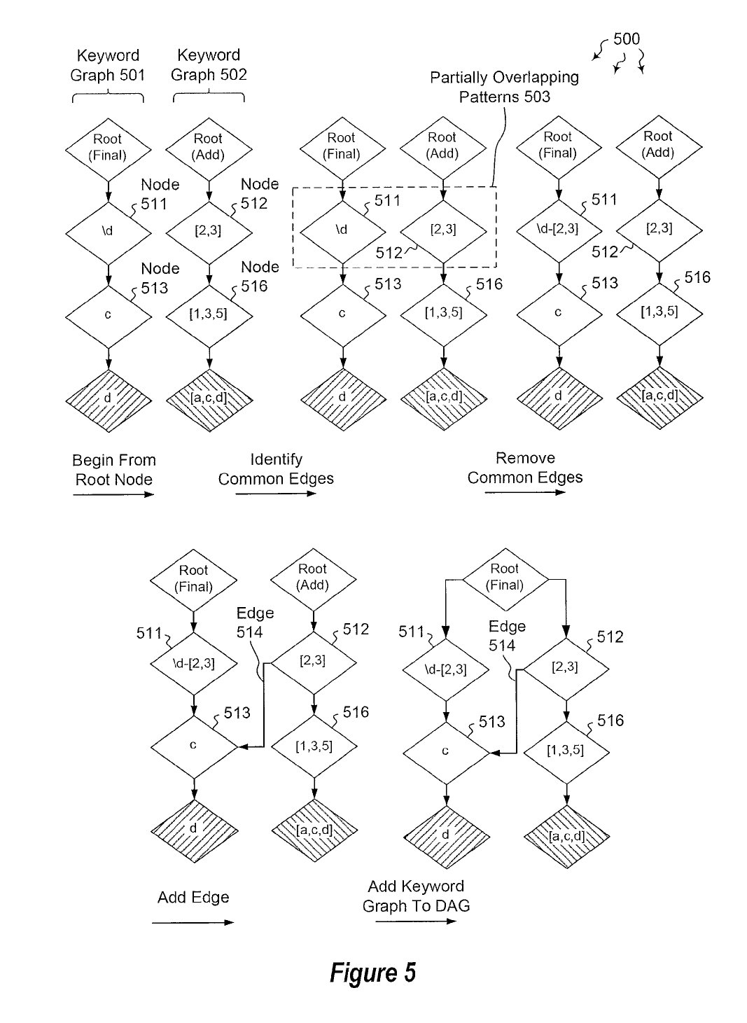

FIG. 5 illustrates another example of merging graphs that represent different regular expressions. Keyword graph 501 and graph 502 can be received as input (e.g., at merge module 141). Position detector 142 can detect that node 511 and node 512 are similarly positioned within keyword graph 501 and graph 502 respectively. Overlap detector 143 can identify partially overlapping patterns 503 (or common edges). That is, character pattern \d partially overlaps the character pattern [2, 3]. Overlap compensator 144 can remove the partial overlap (remove common edges) by altering the character pattern of node 511 to “\d-[2,3]”. Overlap compensator can also add edge 514 from node 512 to node 513. Merge module 114 can then combine root nodes to add (altered) keyword graph 501 to graph 502. Overlap compensation allows graphs to be merged yet still represent equivalent matching states. For example, the text string “2cd” still matches keyword graph 501 even though a comparison is made at node 512 (and node 511 is bypassed).

As depicted, the different hatching within terminal nodes indicates matching states for keyword graph 501 and graph 502 respectively.

In some embodiments, graphs are merge in accordance with the following algorithm:
Create an empty DAG with just a Root node. Label this as the Final.DAG.
For each DAG (i.DAG) in the collection, do the following:
   a. Set i.node as the root node of i.DAG.
   b. Set final.node as the root node of Final.DAG.
   c. Iterate through i.node and final.node as long as final.node has the exact same edge.
   d. If the i.node edge is a superset of the final.node edge:
      i. Add an edge representing the non-common characters between i.node and final.node. This edge points to the child of i.node.
      ii. For each common (edge, node)
         1. Iterate along final.node and i.node as long as they have the exact same edge.
         2. If the terminal node was reached, label it as terminal for i.DAG.
         3. If not, add an edge from the final.node to the i.node's child.
e. If the final.node edge is a superset of the i.node edge:
   i. Add an edge representing the non-common characters between i.node and final.node. This edge points to the child of final.node.
   ii. For each common (edge, node)
      1. Iterate along final.node and i.node as long as they have the exact same edge.
      2. If the terminal node was reached, label it as terminal for final.DAG.
      3. If not, add an edge from the i.node to the final.node's children.

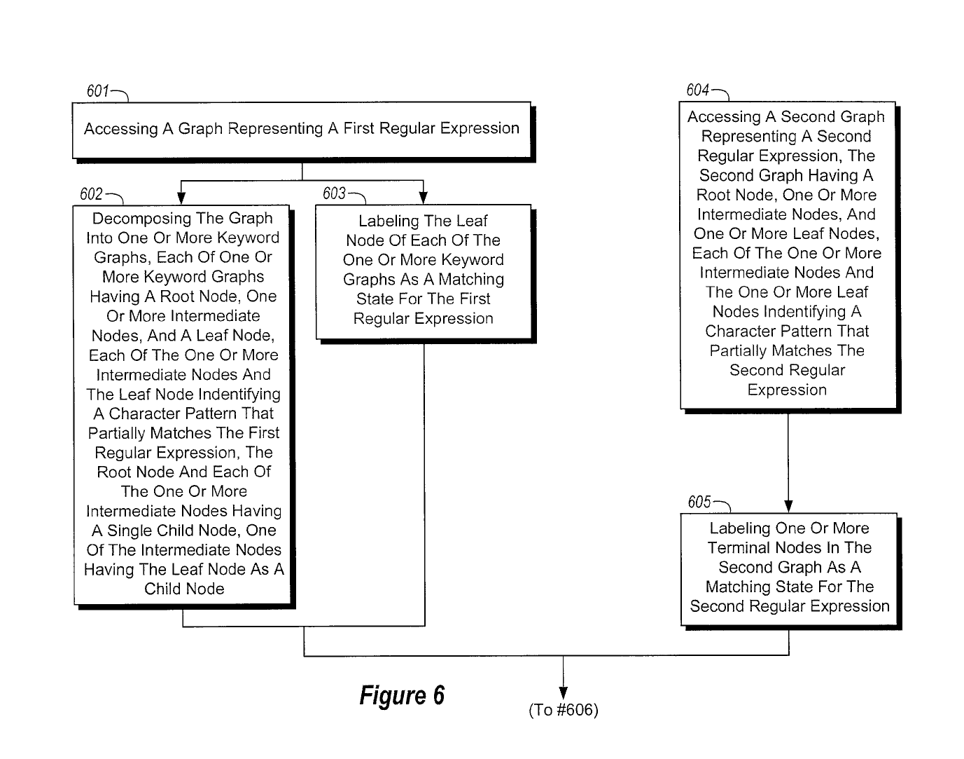

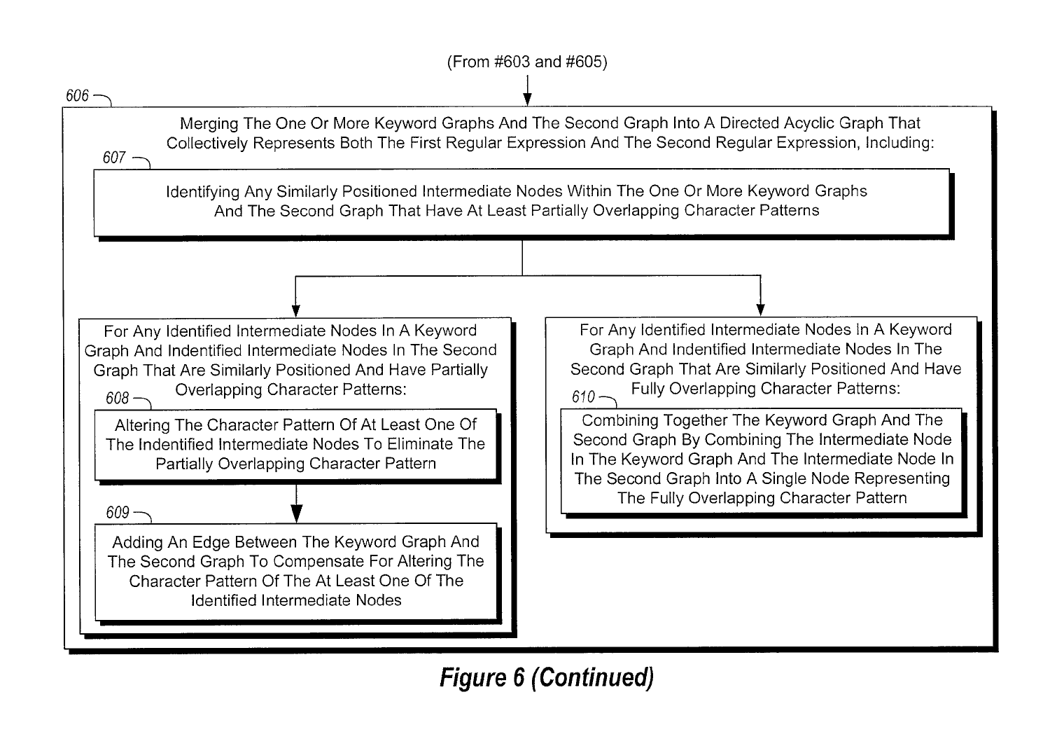

FIG. 6 illustrates a flow chart of an example method 600 for decomposing and merging regular expressions. Method 600 will be described with respect to the components and data of computer architecture 100 and some reference to FIGS. 3 and 5.

Method 600 includes an act of accessing a graph representing a first regular expression (act 601). For example, decomposition module 101 can access graph 112, representing regular expression 111. Method 600 includes an act of decomposing the graph into one or more keyword graphs, each of one or more keyword graphs having a root node, one or more intermediate nodes, and a leaf node, each of the one or more intermediate nodes and the leaf node indentifying a character pattern that partially matches the first regular expression, the root node and each of the one or more intermediate nodes having a single child node, one of the intermediate nodes having the leaf node as a child node (act 602). For example, decomposition module 101 can decompose graph 112 into keyword graphs 113 (e.g., 113A, 113B, 113C, etc.).

Method 600 includes an act of labeling the leaf node of each of the one or more keyword graphs as a matching state for the first regular expression (act 603). For example, labeling module 102 can label the leaf nodes of keyword graphs 113 to generate labeled keyword graphs 113AL, 113BL, 113BL, etc.

Method 600 includes an act of accessing a second graph representing a second regular expression, the second graph having a root node, one or more intermediate nodes, and one or more leaf nodes, each of the one or more intermediate nodes and the one or more leaf nodes indentifying a character pattern that partially matches the second regular expression (act 604). For example, labeling module 102 can access graph 123, representing regular expression 121. Method 600 includes an act of labeling one or more terminal nodes in the second graph as a matching state for the second regular expression (act 605). For example, labeling module 102 can label the terminal nodes of graph 123 to generate labeled graph 123L

Method 600 includes an act of merging the one or more keyword graphs and the second graph into a directed acyclic graph that collectively represents both the first regular expression and the second regular expression (act 606). For example, merge module 141 can mere labeled keyword graphs 113L and labeled graph 123L into directed acyclic graph 134. Directed acyclic graph 134 collectively represents regular expression 111 and regular expression 121.

Act 606 includes an act of an act of identifying any similarly positioned intermediate nodes within the one or more keyword graphs and the second graph that have at least partially overlapping character patterns (act 607). For example, position detector 142 can identify similarly positioned intermediate nodes in one more labeled keyword graphs 113L and labeled graph 123L. Similarly positioned nodes can be nodes that are equidistance from their root node. For example, referring to FIG. 3 nodes 312 and 313 are similarly positioned (both are one edge from their corresponding root node). Similarly, in FIG. 5, nodes 511 and 512 are similarly position. Nodes 513 and 514 are also similarly positioned in FIG. 5.

Among similarly positioned intermediate nodes, overlap detector 143 can detect when nodes have at least partially overlapping character patterns. In FIG. 3, nodes 312 and 313 fully overlap. In FIG. 5, nodes 511 and 512 partially overlap and nodes 513 and 514 do not overlap.

For any identified intermediate nodes in a keyword graph and indentified intermediate nodes in the second graph that are similarly positioned and have partially overlapping character patterns, act 606 includes an act of altering the character pattern of at least one of the indentified intermediate nodes to eliminate the partially overlapping character pattern (act 608). For example, overlap compensator 144 can alter a character pattern at an intermediate node to eliminate a partial overlap with another node. Referring to FIG. 5, character pattern “\d” at node 511 can be altered to “\d-[2,3]” (which is equivalent to [0, 1, 4, 5, 6, 7, 8, 9]) to eliminate the partial overlap with node 512.

For any identified intermediate nodes in a keyword graph and indentified intermediate nodes in the second graph that are similarly positioned and have partially overlapping character patterns, act 606 includes an act of adding an edge between the keyword graph and the second graph to compensate for altering the character pattern of the at least one of the identified intermediate nodes (act 609). For example, overlap compensator 144 can add an edge from a non-altered node to a node below the altered node to compensate for altering the character pattern of the altered node. Referring to FIG. 5, edge 514 can be added from node 512 to node 513 to compensate for altering the character pattern of node 511.

For any identified intermediate nodes in a keyword graph and indentified intermediate nodes in the second graph that are similarly positioned and have fully overlapping character patterns, act 606 includes an act of combining together the keyword graph and the second graph by combining the intermediate node in the keyword graph and the intermediate node in the second graph into a single node representing the fully overlapping character pattern (act 610). For example, overlap compensator 144 can combine an intermediate node of a labeled keyword graph 113L and an intermediate node of labeled graph 123L. Referring to FIG. 3, node 312 and node 313 can be combined into node 314.

Subsequent to creation of a DAG, the DAG can be run on a state machine against a portion of text to determine if the portion of text matches any regular expressions represented in the DAG.

In some embodiments, merging graphs is combined with other passes over regular expressions to facilitate expanding regular expression syntax (e.g. *, +, or number sets). For example, when constructing a DAG to represent regular expressions, it is possible that the entirety of a regular expression cannot be represented by DAG. For example, a regular expression can be include characters such as, ?: or nested * operators.

An increasingly complex state machine can be constructed to handle these types of operators. Another alternative is to create multiple “text processors” that include actual regular expressions and a monolithic DAG. The following algorithm can then be used to merge regular expressions:
Decompose regular expressions into its components that can be represented as a complex DAG and that which cannot.

a. Consider: 123\d\d\d(5.*3)*\d\d\thd
b. This can produce the following components:
   i. DAG: 123\d\d\d|\d\d\d\d
   ii. Regular Expression: (5.*3)*
Run all the “text processors” for regular expressions and the single DAG
Collect the locations in the text at which these text processors were found (already sorted, as guaranteed by the DAG/Regex).
Reassemble the original regular expression based on the results of the DAG and its regular expressions to determine if it was found.
If the results from step (3) are stored in a collection of heaps (e.g. Fibonacci heap), this step is bound by O(n).

As such, a generated DAG can be used with a regular expression engine to produce results for an entire regular expression alphabet. A multi-pass approach also allows for the execution of look-ahead or look-behind regular expressions without in place backtracking or forward tracking, which simplifies the complexity of the system and helps performance.

Accordingly, embodiments of the invention decompose a regular expression into multiple simple keyword graphs, merge those keyword graphs in a compact and efficient manner, and produce a directed acyclic graph (DAG) that can execute a simplified regular expression alphabet. Several of these regular expression DAG's can then be merged together to produce a single DAG that represents an entire collection of regular expressions. DAGs along with other text processing algorithms and a heap collection can be combined in a multi-pass approach to expand the regular expression alphabet.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, a method for representing one or more regular expressions in a directed acyclic graph, the method comprising:
an act of accessing one or more keyword graphs decomposed from a first regular expression, each of one or more keyword graphs having a root node, one or more intermediate nodes, and a leaf node, each of the one or more intermediate nodes and the leaf node indentifying a character pattern that partially matches the first regular expression, the root node and each of the one or more intermediate nodes having a single child node, one of the intermediate nodes having the leaf node as a child node, each leaf node labeled as a matching state for the first regular expression;
an act of accessing a second graph representing at least a part of a second regular expression, the second graph having a root node, one or more intermediate nodes, and one or more leaf nodes, each of the one or more intermediate nodes and the one or more leaf nodes indentifying a character pattern that partially matches the second regular expression;
an act of merging the one or more keyword graphs and the second graph into a directed acyclic graph that collectively represents both the first regular expression and the second regular expression, including for each of the one or more keyword graphs:
an act of selecting the keyword graph individually;
an act of identifying any similarly positioned intermediate nodes within the selected keyword graph and the second graph that have at least partially overlapping character patterns; and
for any identified intermediate nodes in the selected keyword graph and indentified intermediate nodes in the second graph that are similarly positioned and have partially overlapping character patterns, an act of merging the selected keyword graph and the second graph at the indentified intermediate nodes to represent equivalent matching states from the selected keyword graph and the second graph in the directed acyclic graph, the merging causing the keyword graph to become part of the second graph.

2. The method as recited in claim 1, wherein the act of identifying any similarly positioned intermediate nodes within the selected keyword graph and the second graph that have at least partially overlapping character patterns comprises an act of identifying an intermediate node in the selected keyword graph and an intermediate node in the second graph that fully overlap.

3. The method as recited in claim 2, wherein the act of merging the selected keyword graph and the second graph at the indentified intermediate nodes comprises an act of combining the intermediate node in the selected keyword graph and the intermediate node in the second graph into a single node representing the fully overlapping character pattern.

4. The method as recited in claim 1, wherein the act of identifying any similarly positioned intermediate nodes within the selected keyword graph and the second graph that have at least partially overlapping character patterns comprises an act of identifying an intermediate node in the selected keyword graph and an intermediate node in the second graph that partially overlap.

5. The method as recited in claim 4, wherein the act of merging the selected keyword graph and the second graph at the indentified intermediate nodes comprises an act of altering the character pattern of at least one of the indentified intermediate nodes to eliminate the partially overlapping character pattern

6. The method as recited in claim 4, wherein the act of merging the selected keyword graph and the second graph at the indentified intermediate nodes comprises an act of adding an edge between the selected keyword graph and the second graph to compensate for altering the character pattern of the at least one of the identified intermediate nodes.

7. The method as recited in claim 1, further comprising:
an act of accessing a first graph representing the first regular expression; and
an act of decomposing the first graph into the one or more keyword graphs.

8. The method as recited in claim 7, further comprising labeling the leaf node of each of the one or more keyword graphs as a matching state for the first regular expression.

9. The method as recited in claim 1, further comprising labeling each terminal node in the second graph as a matching state for the second regular expression, the terminal nodes selected from among the one or more intermediate nodes and the one or more leaf nodes.

10. The method as recited in claim 1, further comprising running the directed acyclic graph as a state machine against a portion of text to determine if the portion of text matches one or more of: the first regular expression and the second regular expression.

11. The method as recited in claim 1, wherein the second graph is a keyword graph decomposed from the second regular expression.

12. A computer program product for use at computer system, the computer program product for implementing a method for representing one or more regular expressions in a directed acyclic graph, the computer program product comprising one or more computer storage devices, having stored thereon computer-executable instructions that, when executed at a processor, cause the computer system to perform the method, including the following:
access one or more keyword graphs decomposed from a first regular expression, each of one or more keyword graphs having a root node, one or more intermediate nodes, and a leaf node, each of the one or more intermediate nodes and the leaf node indentifying a character pattern that partially matches the first regular expression, the root node and each of the one or more intermediate nodes having a single child node, one of the intermediate nodes having the leaf node as a child node, each leaf node labeled as a matching state for the first regular expression;
access a second graph representing a second regular expression, the second graph having a root node, one or more intermediate nodes, and one or more leaf nodes, each of the one or more intermediate nodes and the one or more leaf nodes indentifying a character pattern that partially matches the second regular expression;
merge the one or more keyword graphs and the second graph into a directed acyclic graph that collectively represents both the first regular expression and the second regular expression, including:
identify any similarly positioned intermediate nodes within the one or more keyword graphs and the second graph that have at least partially overlapping character patterns; and
for any identified intermediate nodes in a keyword graph and indentified intermediate nodes in the second graph that are similarly positioned and have partially overlapping character patterns, merge the keyword graph and the second graph at the indentified intermediate nodes to represent equivalent matching states represented in the keyword graph and in the second graph in the directed acyclic graph.

13. The computer program product as recited in claim 12, wherein computer-executable instructions that, when executed, cause the computer system to identify any similarly positioned intermediate nodes within the one or more keyword graphs and the second graph that have at least partially overlapping character patterns comprise computer-executable instructions that, when executed, cause the computer system to identify an intermediate node in a keyword graph and an intermediate node in the second graph that fully overlap.

14. The computer program product as recited in claim 13, wherein computer-executable instructions that, when executed, cause the computer system to merge the keyword graph and the second graph at the indentified intermediate nodes comprise computer-executable instructions that, when executed, cause the computer system to combine the intermediate node in the keyword graph and the intermediate node in the second graph into a single node representing the fully overlapping character pattern.

15. The computer program product as recited in claim 12, wherein computer-executable instructions that, when executed, cause the computer system to identify any similarly positioned intermediate nodes within the one or more keyword graphs and the second graph that have at least partially overlapping character patterns comprise computer-executable instructions that, when executed, cause the computer system to identify an intermediate node in a keyword graph and an intermediate node in the second graph that partially overlap.

16. The computer program product as recited in claim 15, wherein computer-executable instructions that, when executed, cause the computer system to merge the keyword graph and the second graph at the indentified intermediate nodes comprise computer-executable instructions that, when executed, cause the computer system to alter the character pattern of at least one of the indentified intermediate nodes to eliminate the partially overlapping character pattern

17. The computer program product as recited in claim 15, wherein computer-executable instructions that, when executed, cause the computer system to merge the keyword graph and the second graph at the indentified intermediate nodes comprise computer-executable instructions that, when executed, cause the computer system to add an edge between the keyword graph and the second graph to compensate for altering the character pattern of the at least one of the identified intermediate nodes.

18. The computer program product as recited in claim 12, further comprising computer-executable instructions that, when executed, cause the computer system to label the leaf node of each of the one or more keyword graphs as a matching state for the first regular expression.

19. The computer program product as recited in claim 12, further comprising computer-executable instructions that, when executed, cause the computer system to label each terminal node in the second graph as a matching state for the second regular expression.

20. At a computer system including one or more processors and system memory, a method for representing one or more regular expressions in a directed acyclic graph, the method comprising:
an act of accessing one or more keyword graphs decomposed from a first regular expression, each of one or more keyword graphs having a root node, one or more intermediate nodes, and a leaf node, each of the one or more intermediate nodes and the leaf node indentifying a character pattern that partially matches the first regular expression, the root node and each of the one or more intermediate nodes having a single child node, one of the intermediate nodes having the leaf node as a child node, each leaf node labeled as a matching state for the first regular expression;
an act of accessing a second graph representing a second regular expression, the second graph having a root node, one or more intermediate nodes, and one or more leaf nodes, each of the one or more intermediate nodes and the one or more leaf nodes indentifying a character pattern that partially matches the second regular expression, the second graph having one or more terminal nodes labeled as a matching state for the second regular expression; and
an act of merging the one or more keyword graphs and the second graph into a directed acyclic graph that collectively represents both the first regular expression and the second regular expression, including:
an act of identifying any similarly positioned intermediate nodes within the one or more keyword graphs and the second graph that have at least partially overlapping character patterns;
for any identified intermediate nodes in a keyword graph and indentified intermediate nodes in the second graph that are similarly positioned and have partially overlapping character patterns:
an act of altering the character pattern of at least one of the indentified intermediate nodes to eliminate the partially overlapping character pattern; and
an act of adding an edge between the keyword graph and the second graph to compensate for altering the character pattern of the at least one of the identified intermediate nodes;
for any identified intermediate nodes in a keyword graph and indentified intermediate nodes in the second graph that are similarly positioned and have fully overlapping character patterns:
an act of combining together the keyword graph and the second graph by combining the intermediate node in the keyword graph and the intermediate node in the second graph into a single node representing the fully overlapping character pattern.
